(19) United States
(12) Patent Application Publication
(10) Pub. No.: US 2005/0121257 A1
(43) Pub. Date: Jun. 9, 2005

(54) Survival tower

(76) Inventor: Gilles Desrosiers, Sainte-Catherine (CA)

Correspondence Address: INVENTARIUM, suite 1607, 4050 Rosemont blvd, Montreal, QC, H1X 1M4, CA

(21) Appl. No.: 11/009,918

(22) Filed: Dec. 8, 2004

Related U.S. Application Data
(60) Provisional application No. 60/527,246, filed on Dec. 8, 2003.

(51) Int. Cl. A62B 1/20

(52) U.S. Cl. 182/48

(57) ABSTRACT

A survival tower for rescuing people in an emergency has a new system for controlling traffic inside an emergency chute as well as a new management system for smoke and flames. Instead of trying to keep smoke and flames outside, the system works at eliminating it as soon as it gets in by recirculating the air. As for managing people, they are temporarily slowed down whenever they approach a new entrance which lets time for a new user to get in. Also, a system for receiving people at the end of the chute which slows them down gradually offers a smooth finish to the ride. The system can be built inside a building or built outside such as to retrofit an existing building. A system of vertical ladders also serves as backup should there be any problem with the chute as well as “firemen poles” and a floor by floor elevator system for emergency personnel such as first aid provider and firemen.

### BACKGROUND OF THE INVENTION

1. Field of the Invention

The invention relates generally to rescue and safety equipment and structure but more particularly to a fire/emergency evacuation tower for buidings from 2 storeys to skyscrapers.

2. Background of the Invention

Constructing emergency escape structures for buildings has been known for years and several systems have been developped consisting of an upright tube containing a spiral slide extending throughout its length with access doors along the sides of the tube to allow people to use the device.

Some chutes are made of a double tubular body having an inner cylinder and an outer cylinder made of cloth while other structures are made of rigid material. Besides spiral escapes, there are also elongated or rectangular configuration chutes having a bottom, side walls and a top. Also, vertical stretchable conduits which slow down descent speed by virtue of the fact that they squeeze the users or else offer a soft slightly zigzagging course.

In all cases doorways or hatches of some sort separate the chute from the rest of the building so that smoke or flames won't enter into the chute.

Ther problems with such systems has to do with managing oncoming traffic from new users trying to get in and also stopping fire and smoke from entering the rescue chute.

### SUMMARY OF THE INVENTION

The present invention has a new system for controlling traffic inside an emergency chute as well as a new management system for smoke and flames. Instead of trying to keep smoke and flames outside, the system works at eliminating it as soon as it gets in by recirculating the air. As for managing people, they are temporarily slowed down whenever they approach a new entrance which lets time for a new user to get in. Also, a system for receiving people at the end of the chute which slows them down gradually offers a smooth finish to the ride. The system can be built inside a building or built outside such as to retrofit an existing building. A system of vertical ladders also serves as backup should there be any problem with the chute as well as “firemen poles” and a floor by floor elevator system for emergency personnel such as first aid provider and firemen.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

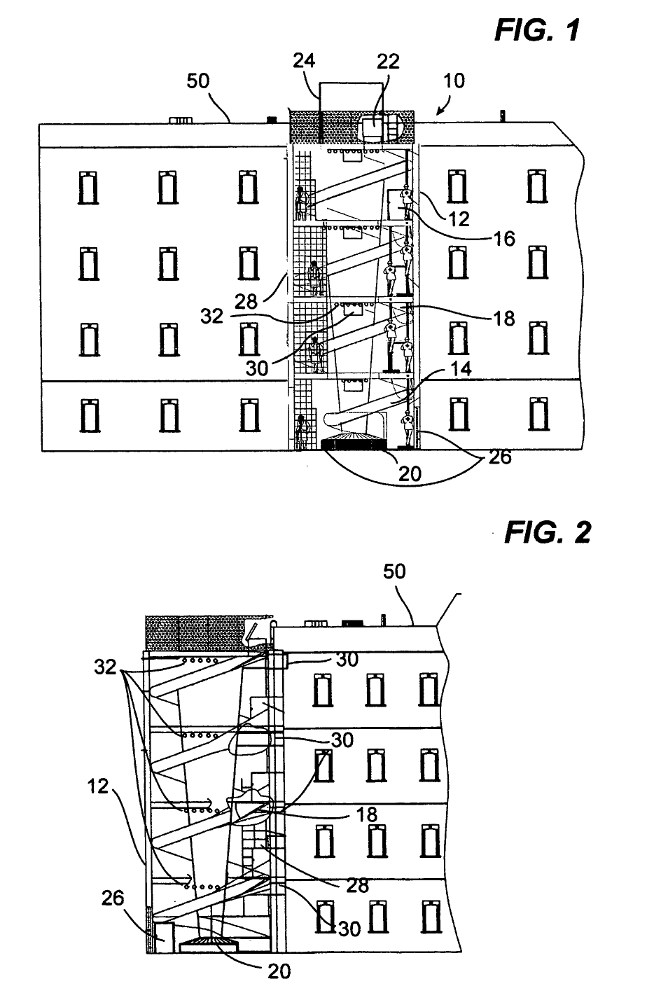

FIG. 1 Front elevation of a buiding having a survival tower.

FIG. 2 Side elevation of FIG. 1.

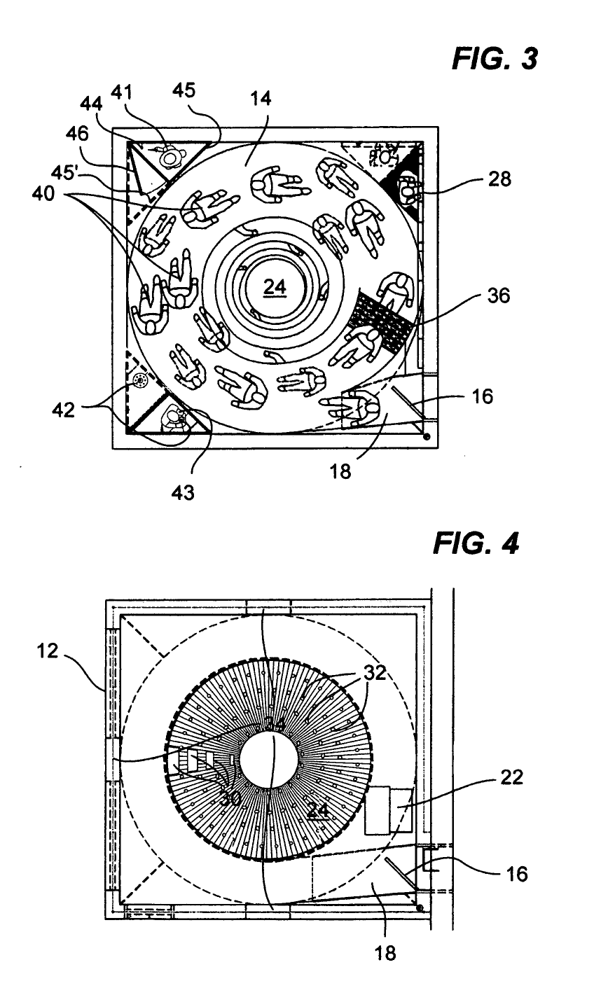

FIG. 3 Plan view of the tower structure, chute and users but without the chimney.

FIG. 4 Plan view of the tower structure showing the chimney.

### DETAILED DESCRIPTION OF THE PREFERRED EMBODIMENT

A survival tower (10) has a tower structure (12) which can be set either inside or outside and adjacent a building (50). Obviously the survival tower (10) is built with fire proof or at least fire retardant materials. The tower structure (12) contains a chute (14) which is a long half tubular structure spiraling down towards the ground. Being half tubular in the sense of being “U” shaped like a tube being cut halfway along its length so that the chute (14) is not a closed environment but rather an open, non claustrophobic environment which is more conducive to adequate air flow and ventilation.

At each floor is a fire retardant access door (16) which is substantially lower than an average door so as to keep smoke from entering the chute (14) since smoke tends to stay higher.

Once a user (40) steps past the access door (16) he walks onto a tipping floor (18) which drops from a horizontal orientation, or angle, onto an orientation substantially matching the angle of the chute (14) when actuated by the weight of the user (40). The tipping floor (18) acts as a gangway of sort which leads the user (40) onto the chute (14). The user (40) will then slide down the chute (14) all the way to a landing platform (20), preferably but not necesarily a rotating landing platform (20) which rotates in a manner similar to an airport carrousel. From the base of the tower structure (12), exit doorways (26) lead outside.

In addition to having the tipping floor (18), which tips back to its closed horizontal configuration, ready to receive the next user (40). By returning to its horizontal angle after the user (40) has left the tipping floor (18) for the chute (14), the tipping floor (18) is ready for the next user (40) and is more reassuring to the next user (40) who may otherwise panic and not know exactly how to enter into the chute (14).

Just before each tipping floor (18) is a slowing down means (36) which is actuated when the tipping floor (18) is actuated by a user (40). The slowing down means (36) slows down the users (40) coming down the chute (14) from a higher floor so as not to interfere with a user (40) coming from the tipping floor (18). The slowing down means (36) can come in the form of a mat consisting of a series of membrane covered rollers similar to a treadmill and when the rollers are temporarily blocked the mat no longer rolls and thus slows down the users (40).

Openings (34) are made from the outside into the chute (14) itself to provide a influx of fresh air for the users and create a positive pressure to keep the smoke from entering into the chute (14).

In order to control the heat, smoke and flames, the central part of the tower structure (12) has a chimney (24) which collects fumes from the building (50) via collecting ducts (30). Additionally, circumferential holes (32) around the inner perimeter of the chimney (24) collect smoke that made its way into the tower structure (12) from the access doors (16).

The tower structure (12) also has other features such as roof access (22) and a backup ladder (28) for use as backups should there be any problem with the chute (14) or if for any of a number of reasons the chute (14) is no longer an option or a user (40) does not want to use the chute (14) or if going up to the roof is a better alternative.

In order to facilitate the displacement of emergency personnel such as firefighters (41) and emergency medical teams (43), at least one sliding pole (42) and at least one elevator (44) at its associated cage (45, 45′) and access door (46) can optionally be added to the survival tower (10), preferably but not necessarily in the unused corners of the tower structure (12). The elevator (44) is limited to moving up or down within a range of two floors with staggered cages (45), dotted cage (45′) being the floor below on FIG. 3. The sliding pole (42) allows one to go from one floor down to the next below floor and is also limited to within a two floor range also in staggered fashion. This limitation allows to break any tendency of smoke and fire to migrate across a large span of floors.

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A survival tower for rescuing people in an emergency having a tower structure adjacent to or within a building and comprising:
said tower structure containing a chute;
at least one access door on each floor;
a tipping floor to interface between said access door and said chute;
said tipping floor able to tip back and forth from a horizontal angle to an angle substantially matching that of said chute;
a landing platform to receive users.
a chimney situated in a central part of said tower structure to collect fumes and heat via collecting ducts;
circumferential holes over the surface of said chimney to collect smoke gathering into said tower structure;
openings made from the outside into said chute to provide an influx of fesh air to create a positive pressure;
a slowing down means actuated by said tipping floor to slow down users in said chute so that they don't conflict with new users entering from said tipping floor.

2. A survival tower for rescuing people in an emergency as in claim 1 wherein:
said slowing down means being in the form of a mat consisting of a series of membrane covered rollers which are temporarily blocked so that said mat no longer rolls and thus slows down said users.

3. A survival tower for rescuing people in an emergency as in claim 1 wherein:
said chute being half tubular.

4. A survival tower for rescuing people in an emergency as in claim 1 wherein:
said landing platform is rotating.

5. A survival tower for rescuing people in an emergency as in claim 1 wherein:
said at least one access door on each floor substantially lower than average door so as to keep smoke from entering said chute.

6. A survival tower for rescuing people in an emergency as in claim 1 wherein:
said tower structure having a roof access.

7. A survival tower for rescuing people in an emergency as in claim 1 wherein:
a backup ladder as backup to said chute.

8. A survival tower for rescuing people in an emergency as in claim 1 wherein:
at least one elevator to allow emergency personnel to move between floors.

9. A survival tower for rescuing people in an emergency as in claim 1 wherein:
at least one sliding pole to allow emergency personnel to slide down to floors below.

10. A survival tower for rescuing people in an emergency as in claim 8 wherein:
said at least one elevator limited to moving up or down within a range of two floors.

11. A survival tower for rescuing people in an emergency as in claim 8 wherein:
at least one elevator being situated in unused corners of the tower structure.

12. A survival tower for rescuing people in an emergency as in claim 9 wherein:
said at least one sliding pole having a range limited to within two floors.

13. A survival tower for rescuing people in an emergency as in claim 9 wherein:
said at least one sliding pole being situated in unused corners of the tower structure.

14. A survival tower for rescuing people in an emergency as in claim 1 wherein:
said tipping floor being actuated by the weight of said user.

15. A survival tower consisting of a tower structure and a chute having the following method of use:
a user enters said tower structure by way of a fire retardant access door;
said access door leading to a tipping floor;
said tipping floor tipping so that its angle substantially matches that of said chute;
said user engaging said chute;
said user sliding down said chute all the way to a landing platform;
from the base of said tower structure, exit doorways lead outside.
